(19) United States
(12) Patent Application Publication
(10) Pub. No.: US 2008/0172744 A1
(43) Pub. Date: Jul. 17, 2008

(54) METHODS AND SYSTEMS TO ASSURE DATA INTEGRITY IN A SECURE DATA COMMUNICATIONS NETWORK

(75) Inventors: John F. L. Schmidt, Phoenix, AZ (US); Alan G. Cornett, Andover, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/624,026

(22) Filed: Jan. 17, 2007

(51) Int. Cl. H04L 9/00; G06F 15/16

(52) U.S. Cl. 726/26; 709/237

(57) ABSTRACT

Methods and systems for assuring data integrity in a secure data communications network are disclosed. In one method, one or more remote data nodes are provided that are in operative communication with a central command unit. The one or more remote data nodes are monitored with the central command unit, and a determination is made whether the one or more remote data nodes has been compromised. A secure erasure wipe command is transmitted from the central command unit to the one or more remote data nodes that have been compromised.

### BACKGROUND

In secure military data communication systems, critical information is passed from central command posts to field commanders, and from field commanders to lower level troops in the field. Data also flows up the chain of command, from the lower levels to the higher levels. Various systems for transmitting and receiving data are currently being employed by the military. These include point-to-point wiring, satellite radio communications, wireless video data transmission, and land-based radio transmissions. Each data node in such a system contains memory, where data can be permanently or temporarily stored. The data in each data node is secure, in that only approved individuals may access and use the data.

In combat or covert military missions, there is a risk that possession of secure data nodes may be transferred to unauthorized parties. In such instances, it is imperative that data on the compromised nodes be erased in a non-recoverable fashion, thereby protecting the larger data system and the individuals using that system.

In some conventional secure systems presently in use, it is possible for an operator to initiate erasure of data while the data node is in the operater's possession if it appears that the data node will be compromised. However, if the operator is rendered incapable of initiating the data erasure, the secure data could fall into the hands of an unauthorized user such as an enemy combatant. For example, if a soldier is rendered unconscious by a concussive blast, is separated from the secure data communication device, or is killed, the secure data node could fall into the possession of hostile forces. In such a case, it would be desirable to render the secure data node inoperative and to wipe the secure data, so that it could not be recovered using forensic engineering processes.

### SUMMARY

The present invention relates to methods and systems for assuring data integrity in a secure data communications network. In one method, one or more remote data nodes are provided that are in operative communication with a central command unit. The one or more remote data nodes are monitored with the central command unit, and a determination is made whether the one or more remote data nodes has been compromised. In such a case where the secure data node has been compromised, a secure erasure wipe command is transmitted from the central command unit to the one or more remote data nodes that have been compromised.

### BRIEF DESCRIPTION OF THE DRAWINGS

Features of the present invention will become apparent to those skilled in the art from the following description with reference to the drawings. Understanding that the drawings depict only typical embodiments of the invention and are not therefore to be considered limiting in scope, the invention will be described with additional specificity and detail through the use of the accompanying drawings, in which:

FIG. 1 is a schematic block diagram depicting a secure data communications network;

FIG. 2 is a schematic block diagram depicting the components of a remote data node that can be used in the secure data communications network of FIG. 1;

FIG. 3 is a flow diagram for a method that can be used by the remote data node of FIG. 2 to assure data integrity;

FIG. 4 is a schematic block diagram depicting communication paths between components in the remote data node of FIG. 2;

FIG. 5 is a flow diagram for a method of wipe selection used by a wipe controller in the remote data node of FIG. 2; and

FIG. 6 is a flow diagram for another method to assure data integrity in a secure data communications network.

### DETAILED DESCRIPTION

In the following detailed description, embodiments are described in sufficient detail to enable those skilled in the art to practice the invention. It is to be understood that other embodiments may be utilized without departing from the scope of the present invention. The following detailed description is, therefore, not to be taken in a limiting sense.

The present methods and systems of the invention provide the capability to securely erase and render useless data terminals and processing modules, herein called data nodes, that fall into hostile or otherwise unauthorized possession. Each data node possesses the capability of processing secure data packets. The present methods and systems enhance such capability, so that remotely issued commands can initiate non-recoverable data/software erasure, and/or can initiate irreparable damage or destruction to hardware, in the selected data node.

For example, when any data node's possession has been compromised, a central command unit can initiate transparent data erasure on that node via a remotely transmitted command. When the data node is remotely commanded to perform self-erasure and/or self-destruction, the possessor has no indication that any untoward action is occurring, until after such action has been completed. In addition, the data node can be configured such that self-erasure and/or self-destruction can be initiated by a data node operator, or by the node itself when unauthorized access or use occurs.

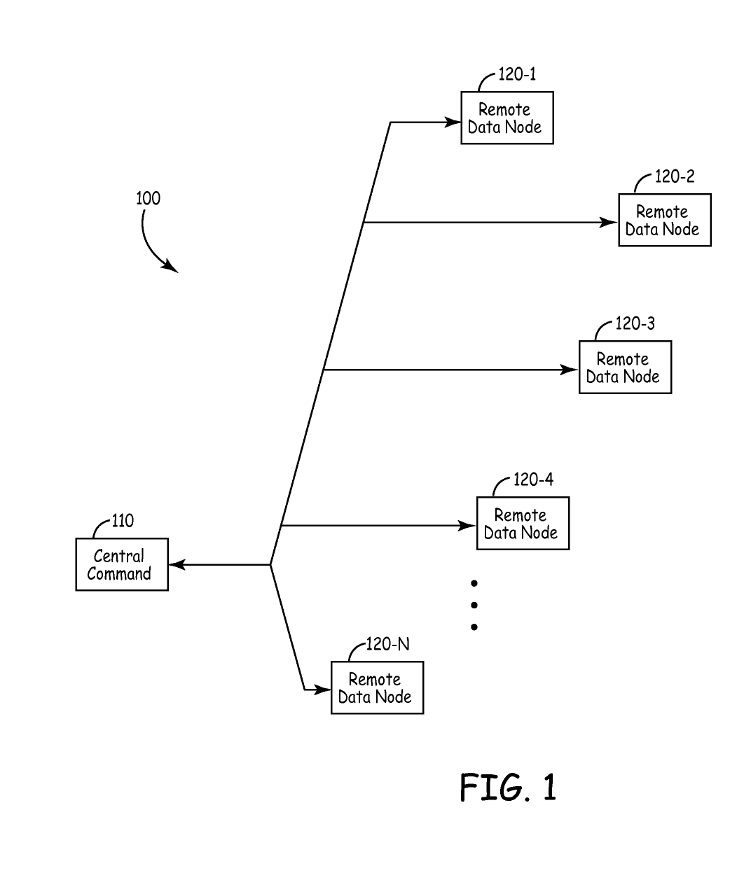

FIG. 1 is a schematic diagram depicting a secure data communications network 100 that can be implemented with the methods and systems of the invention. The communications network 100 includes a central command unit 110 that monitors a plurality of distributed remote data nodes, such as remote data nodes 120-1, 120-2, 120-3, 120-4, . . . 120-N. While only five data nodes are depicted in FIG. 1, it should be understood that more or less data nodes may be in operative communication with central command unit 110. In addition, the data nodes can be placed in a hierarchical system with other intermediate data nodes (e.g., field command units) that communicate with central command unit 110.

The remote data nodes can be a variety of electronic devices, such as computers, personal digital assistants, cellular telephones, positioning equipment, communications equipment, and the like. When used in a military environment, the data nodes can be handheld units used by dismounted soldiers, one or more land vehicle mounted units, a field command fixed position or mobile unit, one or more aircraft mounted units, one or more watercraft mounted units, or the like.

Secure data transmission can occur between the remote data nodes, or between any remote data node and central command 110. Security authentication occurs only between central command unit 110 and each individual remote data node. Special commands can be embedded into the data stream between the central command unit and the distributed remote data nodes. For example, a secure erasure (or wipe) command can remotely initiate a data wipe of a target data node when unauthorized use of the data node is detected by the central command unit.

Depending on the required security level, remote data node authentication can be required at the start of each initiated data transmission, or periodically during unit operation. As long as a data node is enabled by central command unit 110, the data node will operate per its mission profile. If a data node is deemed to be compromised, central command unit 110 can send a signal to deactivate and incapacitate the data node.

For example, an automated initialization sequence can be implemented wherein each data node communicates with central command unit 110. If central command unit 110 determines that one or more data nodes have been compromised, a secure erase (wipe) command will be issued by central command unit 110 as part of the data node's initialization sequence. The affected data node will initiate secure data erasure as soon as it receives the erase command. The remote data node will appear to be initializing or operating normally to the unauthorized user while secure data erasure is occurring. When the secure data erasure has been completed, the data node will erase its program memory, initiate a destructive voltage pulse, and cease to operate. Alternatively, when magnetically sensitive data storage media is utilized, the remote data node can be configured so that irreparable damage is carried out by application of a magnetic field to the storage media.

The central command unit can detect whether a data node has been compromised in various ways. For example, an RF (radio frequency) link can be established between the data node and an authorized user. If the RF link is broken for more than a predetermined amount of time, the data node is deemed to be compromised. The data node sends a signal to the central command unit indicating that the RF link is broken, and a secure erasure wipe command is transmitted to the data node to initiate erasure of data and/or damage to internal hardware.

Once secure erasure has occurred there is an extremely low probability that postmortem analyses could reveal the memory contents of a data node prior to the secure data erasure. The secure data erasure of node data and damage to the node hardware ensure that unauthorized possessors of the data node cannot retrieve data from the node, or use the node to gain access to a central data system.

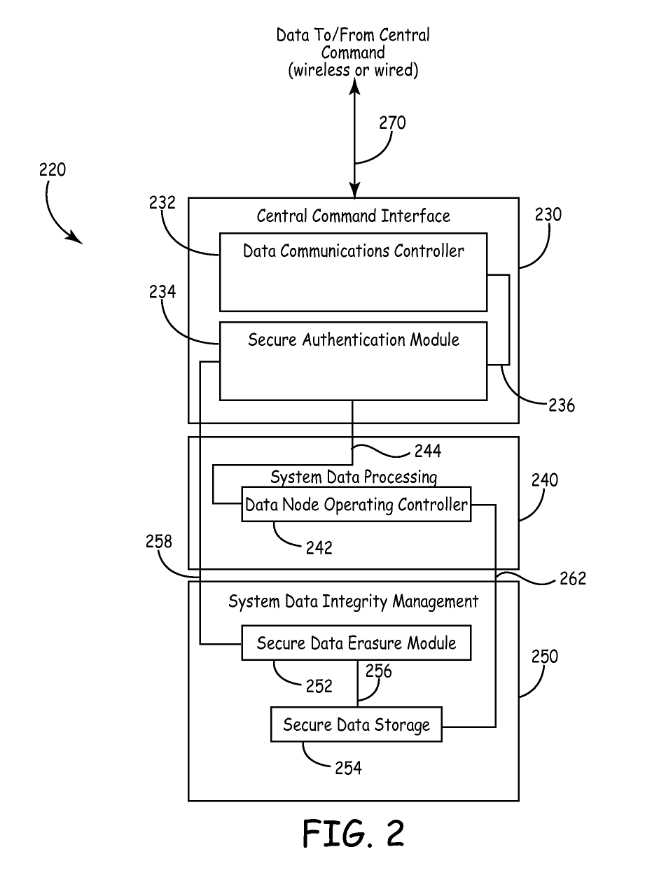

FIG. 2 is a schematic diagram depicting components of a remote data node 220 that can be used in communications network 100. The data node 220 includes a central command interface unit 230, a system data processing unit 240, and a system data integrity management unit 250.

The central command interface unit 230 includes a data communications controller 232 that provides handshaking with a central command unit such as command unit 110 of FIG. 1. The data communications controller 232 can be implemented with a standard operational protocol such as SCIP (secure communications interoperability protocol). The central command interface unit 230 also has a secure authentication module 234 that is in operative communication with data communications controller 232 via a communication link 236. The secure authentication module 234 establishes a secure data link, and provides data encryption and decryption.

The system data processing unit 240 has a data node operating controller 242 that operatively communicates with secure authentication module 234 via a communication link 244, which provides for enabling/disabling of encrypted data communications. The data node operating controller 242 provides data processing functions for normal operation of data node 220.

The system data integrity management unit 250 includes a secure data erasure module 252, and a secure data storage device 254 in operative communication with secure data erasure module 252 via a communication link 256. The secure data erasure module 252 operatively communicates with secure authentication module 234 via a communication link 258. The secure data storage device 254 is also in operative communication with data node operating controller 242 via a communication link 262.

During operation, a secure communications data link 270 is established between central command unit 110 and central command interface 230, including data communications controller 232 and secure authentication module 234. The secure data communications link 270 provides for data input from and data output to central command unit 1 10. The secure data link 270 can be implemented in a wireless network, a wired network, or a combination of both. When a wipe command is transmitted by central command unit 110, secure authentication module 234 sends a control signal to secure data erasure module 252 to initiate secure data obliteration by erasure of software and/or sending an electrical pulse or applying a magnetic field to hardware.

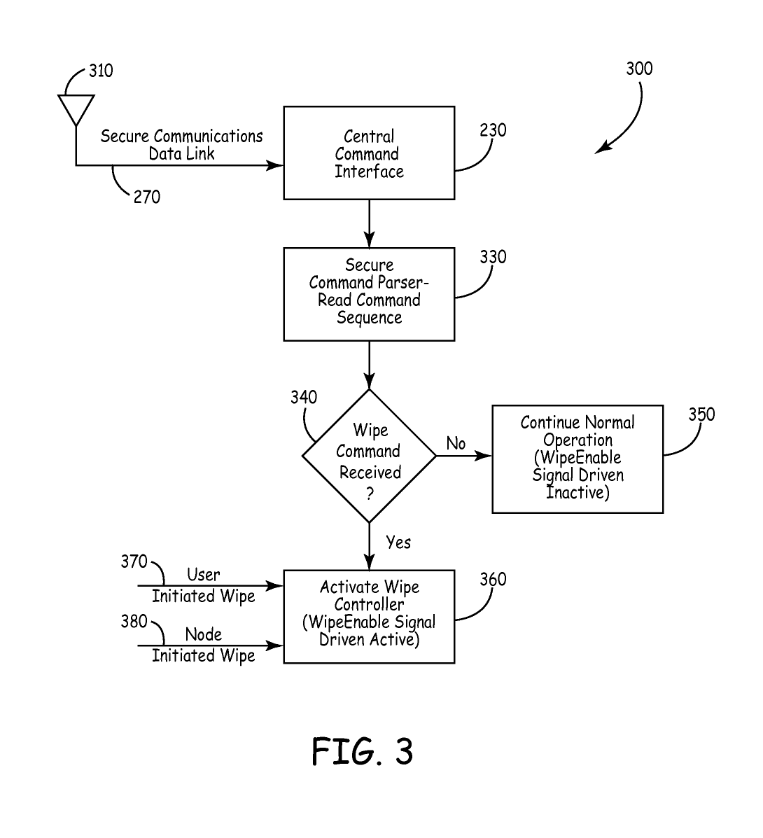

FIG. 3 is a flow diagram for a method 300 that can be used by remote data node 220 to assure data integrity in a secure data communications network. With the secure communications data link 270 established with central command interface 230, such as through an antenna unit 310, a secure command parser reads a command sequence at 330, and determines whether a wipe command has been received at 340. If no wipe command is received, then normal operation of the remote data node is continued at 350 (with a wipe enable signal driven inactive). If a wipe command is received, then the wipe controller is activated at 360 (with a wipe enable signal driven active). Such a wipe command can be transmitted via a land-based radio signal or a satellite radio signal to remotely initiate the wipe of the data node.

In an optional implementation shown in FIG. 3, the wipe controller can be activated at 360 by transmission of a user initiated wipe command 370. Such an implementation is useful when capture of a remote data node by an unauthorized user such as an enemy combatant is imminent. The user initiated wipe command 370 can be generated from a conventional zeroize function (“Z-function”) button located on the remote data node, to implement non-recoverable erasure of secure data within the node. This renders the data node useless to enemy forces since the wiping function will destroy internal data in a non-recoverable fashion. The Z-function button can also be configured to initiate internal electronics component damage after erasure of the secure data. The hardware damage will prevent hostile forces from analyzing the node hardware using traditional hardware analysis and debugging tools.

For example, when a user such as a soldier detects impending loss of the data node to hostile forces, the user can push the Z-function button to both erase data and cause microscale destruction of the electronic components using a high voltage pulse generated in the data node. The high voltage pulse will not pose a risk to the user, with only the sensitive electronic components being affected. The high voltage pulse can range from about 25 volts to about 50 volts, for example.

The remote data node can also be configured with another button that immediately initiates internal electronics component damage. This is useful when loss of the data node is imminent such that there is not time to carry out both data erasure and hardware damage.

Alternatively, the remote data node can be configured to send a signal to the central command unit when a user presses a Z-function button. The central command unit in turn transmits a wipe command back to the data node.

In another optional implementation shown in FIG. 3, the wipe controller can be activated at 360 by transmission of a data node initiated wipe command 380. For example, in the event that the data node's chassis integrity has been violated, such as by chassis cover removal, battery cover removal, or other detectable intrusion into the data node's physical structure, self-erasure and/or self destruction of the data node can be automatically initiated without a remote command or user input.

For data nodes that require entry of a code at start-up or periodically, the data node initiated wipe command 380 can be transmitted to activate the wipe controller automatically when an erroneous code is entered by an operator using the data node. Alternatively, the remote data node can be configured to send a signal to the central command unit when an erroneous code is entered. The central command unit in turn transmits a wipe command back to the data node.

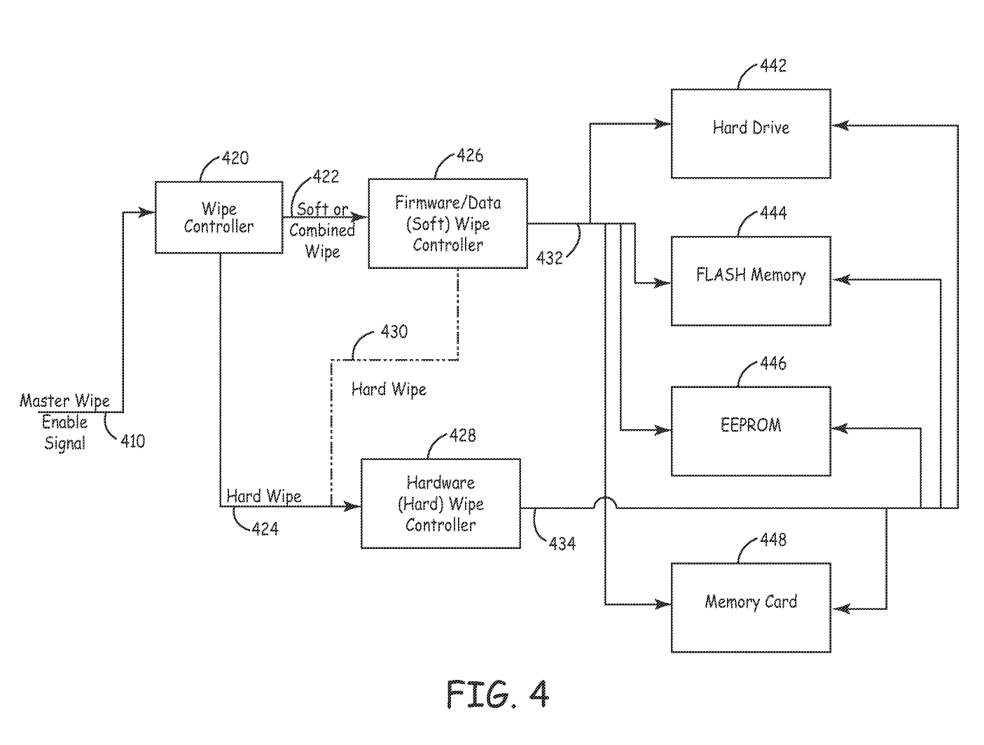

FIG. 4 is a schematic diagram depicting communication paths between components in a remote data node, such as data node 220, to carry out wiping of software (firmware)/data and hardware when needed. A master wipe controller 420 can be located in the secure data erasure module 252, and is in operative communication with a soft wipe controller 426 and a hard wipe controller 428. The master wipe controller 420 is configured to transmit a soft wipe or combined wipe signal 422, and a hard wipe signal 424.

When a master wipe enable signal 410 is detected by wipe controller 420, the soft wipe or combined wipe signal 422 is sent to soft wipe controller 426. When a soft wipe signal is sent from master wipe controller 420, soft wipe controller 426 initiates erasure of data and program memory in one or more memory storage devices, for which in-situ erasure is available, through a communication medium 432. Exemplary memory storage devices are shown in FIG. 4, such as a hard drive 442, a flash memory 444, an EEPROM (electronically erasable programmable read-only memory) 446, and a memory card 448 such as a SRAM (static random access memory). When a hard wipe signal 424 is sent from master wipe controller 420, hard wipe controller 428 initiates physical, microscopic damage to the memory storage devices that are used, such as through a high voltage electrical pulse carried on an electrical communication medium 434. For example, the high voltage pulse can be applied to a digital logic bus, to initiate physical damage to voltage sensitive silicon that is used in semiconductor devices.

When a combination of software and hardware wipes are utilized, data security is enforced via a two-step process: 1) erasure of data and program memory in the memory storage devices, and then 2) initiation of physical damage to the memory storage devices. For example, when a combined wipe signal is transmitted from master wipe controller 420, soft wipe controller 426 initiates erasure of data and program memory in the memory storage devices. A hard wipe signal 430 is then transmitted from soft wipe controller 426 to hard wipe controller 428, which initiates physical, microscopic damage to the memory storage devices.

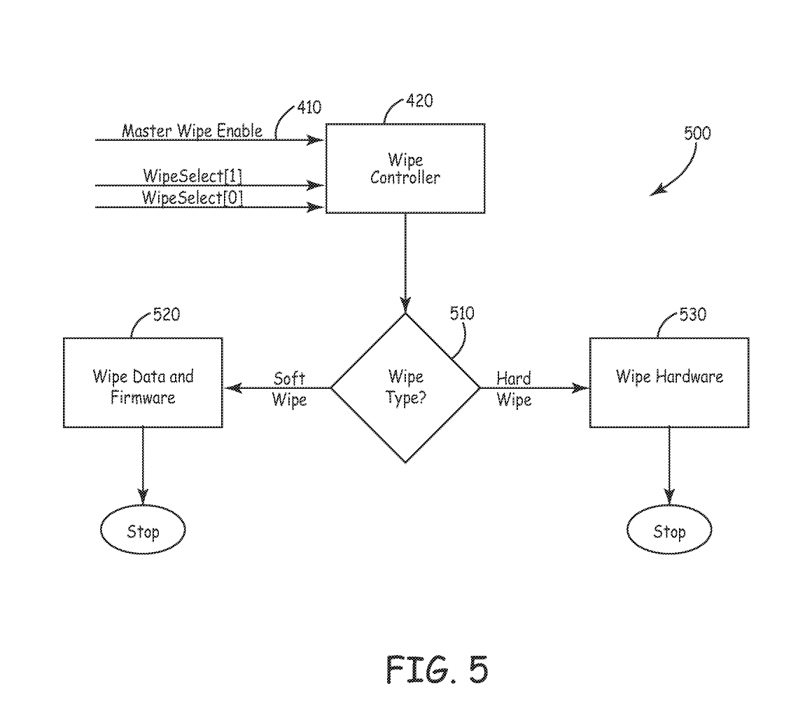

FIG. 5 is a flow diagram showing a method of wipe selection 500 that can be used by a wipe controller such as wipe controller 420 in FIG. 4. The wipe controller 420 is configured to receive incoming control signals, and waits for a set of conditions to occur before initiating a wipe type 5 10. Such conditions provide for flexibility in wiping data and firmware at 520, wiping hardware at 530, or a combination of both. Such flexibility can be afforded by two incoming wipe select bits. As shown in FIG. 5 for example, master wipe enable signal 410 can be detected by wipe controller 420, and a wipe type can be coded in two incoming wipe select bits: WipeSelect[0] and WipeSelect[1]. A representative encoding for the wipe types is shown in Table 1.

TABLE 1

| WipeSelect [0:1] | Wipe Type | Master Wipe Enable |
|---|---|---|
| 0x0 | Normal Operation (No Wipe) | 1 or 0 |
| 0x1 | Soft Wipe | 1 |
| 0x2 | Hard Wipe | 1 |
| 0x3 | Combination Wipe | 1 |

As indicated in Table 1, WipeSelect [0×0] represents a normal operation signal with no wipe, WipeSelect [0×1] represents a soft wipe, WipeSelect [0×2] represents a hard wipe, and WipeSelect [0×3] represents a combination of soft wipe and hard wipe. The wipe controller 420 initiates a single wipe sequence (soft or hard), or sequential wipe sequence (soft and hard), depending upon which wipe type is needed. In addition, the wipe controller can be configured to initiate two sets of signals simultaneously for a given wipe type so that an accidental wipe is avoided.

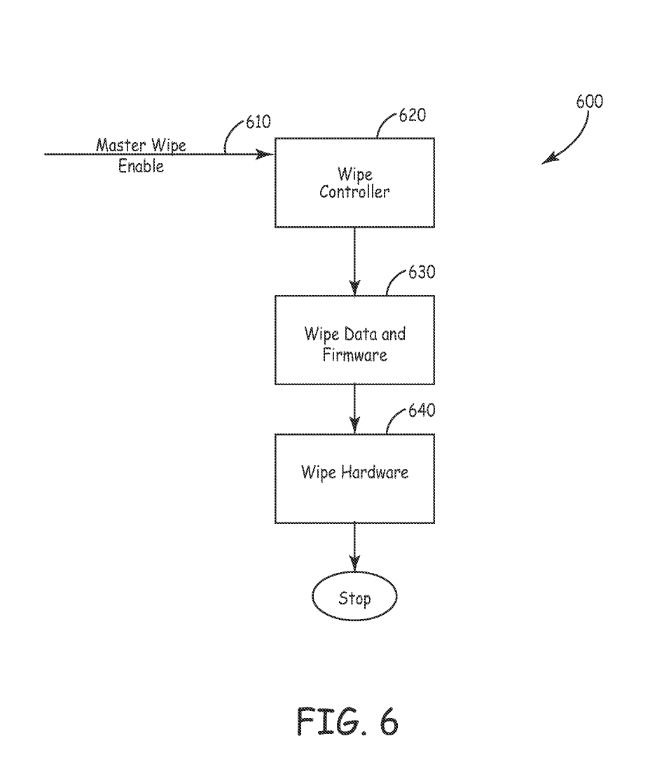

FIG. 6 is a flow diagram for another method 600 to assure data integrity in a secure data communications network. The method 600 uses a single step combined wipe of data/firmware and hardware in a remote data node. A master wipe enable signal 610 is sent to a wipe controller 620 in the remote data node. After the wipe enable signal 610 is detected, wipe controller 620 initiates sequentially the soft wipe of data and firmware at 630, and then the hard wipe of the hardware at 640.

While the combined wipe shown in FIG. 6 represents the highest security level, it is possible that in some systems the soft wipe would take too much time. For example, it might take many minutes to securely erase a hard drive. In such cases, implementing only a hard wipe would be more prudent than using the slower combined wipe. In addition, the combined wipe process would typically be most appropriate for devices that support rapid erasure of stored data.

Instructions for carrying out the various process tasks, calculations, and generation of signals and other data used in the operation of the methods and systems of the invention can be implemented in software, firmware, or other computer readable instructions. These instructions are typically stored on any appropriate computer readable medium used for storage of computer readable instructions or data structures. Such computer readable media can be any available media that can be accessed by a general purpose or special purpose computer or processor, or any programmable logic device.

Suitable computer readable media may comprise, for example, non-volatile memory devices including semiconductor memory devices such as EPROM, EEPROM, or flash memory devices; magnetic disks such as internal hard disks or removable disks; magneto-optical disks; CDs, DVDs, or other optical storage disks; nonvolatile ROM, RAM, and other like media; or any other media that can be used to carry or store desired program code means in the form of computer executable instructions or data structures. Any of the foregoing may be supplemented by, or incorporated in, specially-designed application-specific integrated circuits (ASICs). When information is transferred or provided over a network or another communications connection (either hardwired, wireless, or a combination of hardwired or wireless) to a computer, the computer properly views the connection as a computer readable medium. Thus, any such connection is properly termed a computer readable medium. Combinations of the above are also included within the scope of computer readable media.

The methods and systems of the invention can be implemented in computer readable instructions, such as program modules or applications, which are executed by a data processor. Generally, program modules or applications include routines, programs, objects, data components, data structures, algorithms, etc. that perform particular tasks or implement particular abstract data types. These represent examples of program code means for executing steps of the methods disclosed herein. The particular sequence of such executable instructions or associated data structures represent examples of corresponding acts for implementing the functions described in such steps.

The present invention may be embodied in other specific forms without departing from its essential characteristics. The described embodiments are to be considered in all respects only as illustrative and not restrictive. The scope of the invention is therefore indicated by the appended claims rather than by the foregoing description. All changes that come within the meaning and range of equivalency of the claims are to be embraced within their scope.

What is claimed is:

1. A method for assuring data integrity in a secure data communications network, the method comprising:
providing one or more remote data nodes in operative communication with a central command unit;
monitoring the one or more remote data nodes with the central command unit;
determining whether the one or more remote data nodes has been compromised; and
transmitting a secure erasure wipe command from the central command unit to the one or more remote data nodes that have been compromised.

2. The method of claim 1, wherein the one or more remote data nodes is in operative communication with one or more additional remote data nodes.

3. The method of claim 1, wherein the wipe command initiates erasure of data and software in the one or more remote data nodes.

4. The method of claim 1, wherein the wipe command initiates irreparable damage to hardware in the one or more remote data nodes.

5. The method of claim 4, wherein the irreparable damage to the hardware is carried out by:
generating a voltage pulse in the remote data node; or
applying a magnetic field to magnetically sensitive data storage media in the remote data node.

6. The method of claim 5, wherein the hardware comprises one or more memory storage devices, and the voltage pulse causes physical, microscopic damage to the one or more memory storage devices.

7. The method of claim 1, wherein the wipe command initiates erasure of all data and software, and then initiates irreparable damage to hardware in the one or more remote data nodes.

8. A method for assuring data integrity in a secure data communications network, the method comprising:
providing a remote data node in operative communication with a central command unit; and
transmitting a secure erasure wipe command when the remote data node has been or will be compromised, the wipe command comprising:
initiating irreparable damage to hardware in the remote data node.

9. The method of claim 8, wherein the wipe command initiates erasure of data and software in the remote data node prior to initiating irreparable damage to hardware in the remote data node.

10. The method of claim 9, wherein transmitting of the wipe command is initiated by a user of the remote data node.

11. The method of claim 9, wherein transmitting of the wipe command is initiated by the central command unit after receiving a signal from the remote data node that an RF link between a user and the remote data node has been broken.

12. The method of claim 9, wherein transmitting of the wipe command is initiated automatically when a chassis of the remote data node is violated.

13. The method of claim 9, wherein transmitting of the wipe command is initiated automatically when an erroneous code is entered for using the remote data node.

14. The method of claim 8, wherein the irreparable damage to the hardware is carried out by:
generating a voltage pulse in the remote data node; or
applying a magnetic field to magnetically sensitive data storage media in the remote data node.

15. A remote data node for assuring data integrity in a secure data communications network, the remote data node comprising:
a central command interface unit comprising:
a data communications controller that provides for handshaking with a central command unit; and
a secure authentication module in operative communication with the data communications controller;
a system data processing unit comprising:
a data node operating controller in operative communication with the secure authentication module;
a system data integrity management unit comprising:
a secure data erasure module in operative communication with the secure authentication module; and
a secure data storage device in operative communication with the secure data erasure module and the data node operating controller;
wherein the secure data erasure module is configured to initiate erasure of data and software, and initiate irreparable damage to hardware, in the secure data storage device.

16. The remote data node of claim 15, wherein the secure data erasure module comprises a master wipe controller.

17. The remote data node of claim 16, wherein the master wipe controller is in operative communication with a soft wipe controller and a hard wipe controller.

18. The remote data node of claim 16, wherein the master wipe controller is configured to transmit a soft wipe signal, a hard wipe signal, or a combined soft/hard wipe signal.

19. The remote data node of claim 17, wherein the hard wipe controller is configured to initiate irreparable damage to the hardware in the secure data storage device by:
a voltage pulse generated in the remote data node; or
a magnetic field applied to magnetically sensitive data storage media in the secure data storage device.

20. A secure data communications network comprising at least one remote data node according to claim 15.
